(19) United States
(12) Patent Application Publication
(10) Pub. No.: US 2009/0135108 A1
(43) Pub. Date: May 28, 2009

(54) Sample-and-Hold Display with Impulse Backlight

(76) Inventors: Max Lindfors, Helsingfors (FI); Johan Bergquist, Tokyo (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/227,924

(22) PCT Filed: May 31, 2006
(86) PCT No.: PCT/IB2006/051736

§ 371 Date: Dec. 1, 2008

(51) Int. Cl. G09G 3/30; G09G 3/36

(52) U.S. Cl. 345/76; 345/102

(57) ABSTRACT

An apparatus includes a sample-and-hold display with a plurality of transmissive aperture holes, and an electroluminescent backlight source with a plurality of delimited emissive areas. A dedicated delimited emissive area is associated to each transmissive aperture hole of the sample-and-hold display. A display control component updates the sample-and-hold display with a predetermined refresh rate. A backlight control component activates different portions of the electroluminescent backlight source sequentially, each portion comprising a plurality of the emissive areas.

### FIELD OF THE INVENTION

The invention relates to an apparatus and to an electronic device comprising a sample-and-hold display. The invention relates equally to a method, to a computer program code and to a computer program product that can be used with a sample-and-hold display.

### BACKGROUND OF THE INVENTION

A screen of an electronic device can be realized for example with a flat liquid crystal display (LCD). An LCD may comprise an array of pixels, which is arranged in front of a backlight source. Each pixel may be composed of sub-pixels for different colors, and the amount of light passing each sub-pixel can be set by applying a variable voltage to the sub-pixel.

In contrast to cathode ray tube (CRT) displays, conventional LCDs have a sample-and-hold characteristic. That is, when a luminance value is assigned to a sub-pixel of the LCD during an image refresh cycle, the sub-pixel keeps this value for a while. The actual hold time may be determined by the voltage holding ratio (VHR), the capacitance in a storage capacitor of a respective pixel and the electrical decay time of the liquid crystal molecules. Some display driver circuits are able to turn all pixels to black by a collective black field insertion before the arrival of the data for the next frame. Due to this hold-time, presentations of video content on displays with a sample-and-hold characteristic suffer from a motion blur effect. The effect is particularly severe in the case of smooth eye-tracking pursuit of moving objects in a presented scene.

In a TV set using an LCD screen, the backlight source typically includes an array of fluorescent lamps that are positioned directly behind the LCD. Thus, each sub-pixel filters essentially only light that is provided by a single one of the fluorescent lamps. In this case, the motion blur effect may be reduced by flashing the backlight in synchrony with the refresh cycles of the LCD. For example, if the backlight source comprises six fluorescent lamps, all six lamps may be lit in sequence during a refresh cycle so that only one lamp is lit at a time, which is also referred to as “scanning backlight”. This reduces the visible hold time of the LCD sub-pixels to ⅙ of the true hold time and consequently reduces the amount of motion blur that is experienced by a user.

Using an array of fluorescent lamps, however, is not a viable solution with small displays, as used for example in mobile terminals. Thus, providing a scanning backlight is more difficult to realize for small displays.

The problem of the limited available space could be solved by implementing a scanning backlight by means of patterned stripes of organic light-emitting diode (OLED) emitters or a light guide with separate sections illuminated by individual light-emitting diodes (LEDs).

### SUMMARY OF THE INVENTION

The invention enables an efficient reduction of motion blur of a sample-and-hold display. The invention further enables an efficient exploitation of light that is provided by a backlight source.

An apparatus is proposed, which comprises a sample-and-hold display with a plurality of transmissive aperture holes and an electroluminescent backlight source with a plurality of delimited emissive areas. A dedicated delimited emissive area is associated to each transmissive aperture hole of the sample-and-hold display. The apparatus further comprises a display control component configured to update the sample-and-hold display with a predetermined refresh rate. The apparatus further comprises a backlight control component configured to activate different portions of the electroluminescent backlight source sequentially, each portion comprising a plurality of the emissive areas.

The term emissive area denotes any concrete area of the backlight source that can be caused to emit light, for example by applying a voltage or a current. These emissive areas are delimited in the sense that they are surrounded by a non-emissive area. This may mean for example that only the emissive areas comprise electroluminescent material, or that extended electroluminescent material can only be activated in the emissive areas. The delimited emissive areas may be for instance small dots distributed to the total area of the backlight source

A respective portion of the electroluminescent backlight source could be for example a contiguous segment, but equally a cluster of discontiguous emissive areas, etc.

The control components of the proposed apparatus can be realized in hardware and/or software. They could be realized for example as electronic circuits integrated in a chip or in a chipset. Alternatively, they could be realized for example by a processor executing corresponding software program code.

The apparatus could be for example a display module for some electronic device, a part of a display module, or a more comprehensive entity.

Moreover, an electronic device is proposed, which comprises the same components as the proposed apparatus and in addition a user input component. The user input component could include for instance a keypad, a button or a microphone, a touch screen, an optical sensor, etc.

Moreover, a method is proposed, which comprises updating a sample-and-hold display comprising a plurality of transmissive aperture holes with a predetermined refresh rate. The method further comprises sequentially activating different portions of an electroluminescent backlight source comprising a plurality of delimited emissive areas. A dedicated delimited emissive area is associated to each transmissive aperture hole of the sample-and-hold display, and different portions of the electroluminescent backlight source are activated such that each portion comprises a plurality of the emissive areas of the electroluminescent backlight source.

Moreover, a computer program code is proposed, which realizes the steps of the proposed method when executed by a processor.

Finally, a computer program product is proposed, in which the proposed computer program code is stored in a computer readable medium. Such a computer program product can be for example a separate memory device, a memory for an electronic device comprising the sample-and-hold display, etc.

The invention proceeds from the consideration that while an electroluminescent backlight source may be used for realizing a scanning backlight in a small space, a uniform or line-shaped backlight will illuminate areas around the display aperture holes. As a result, most of the light is absorbed rather than passing the apertures, which reduces the efficacy of the backlight.

In contrast to fluorescent lamps, the proposed electroluminescent backlight source can be very thin, for example sandwiched between a lower substrate of the display and a thin film passivation layer, so that the invention can be employed as well for small sample-and-hold displays in small devices. The proposed pulsing of the backlight reduces the motion blur that is experienced by the user of the sample-and-hold display. The partitioning of the backlight source is suited to limit the effort for controlling the electroluminescent backlight source for the pulsing. The different portions can be limited to a small number, for example 5 to 10 different portions, or any number that can be driven by drivers of the electroluminescent backlight source.

By providing that a dedicated delimited emissive area is associated to each transmissive aperture hole of the sample-and-hold display, the backlight source may further be structured such that most of the area is not producing light. For instance, the emissive areas could be very small spots that are placed beneath the transmissive aperture holes of the display, such that the center of a respective emissive area lies below the center of a respective aperture hole. By ensuring that the backlight source illuminates essentially only the area of the aperture holes, the light throughput can be maximized and the total luminous efficacy can be increased substantially. The size of the delimited emissive areas or the size of the areas of the display that are illuminated by the emissive areas could be limited to this end for example to be at the most twice the size of the aperture holes. The increased efficacy is also suited to compensate for the effect that a pulsed backlight results in a reduced total light intensity compared to a continuously provided backlight.

Even if patterned electroluminescent backlight sources are used, the amount of moving image quality improvement is limited with line-wise scanning backlights. In an exemplary embodiment of the invention, in which the emissive areas are arranged in lines and columns, the portions are therefore selected such that at least two portions are required for addressing all emissive areas of a respective entire line of emissive areas.

In an exemplary embodiment of the invention, the backlight control component is configured to activate different portions of the electroluminescent backlight source sequentially with a repetition rate that is equal to or an integer multiple of the refresh rate used by the display control component.

In a further exemplary embodiment of the invention, the backlight control component is configured to synchronize the sequential activation of different portions of the electroluminescent backlight source with an update applied by the display control component to the sample-and-hold display.

Each transmissive aperture hole could be associated to a respective pixel of the sample-and-hold display or to a respective sub-pixel of a pixel of the sample-and-hold display. Currently, displays usually comprise 1, 3, 4 or 5 sub-pixels per pixel. It is to be understood, however, that embodiments of the invention can be employed with any other number of sub-pixels as well.

The electroluminescent backlight source could be applied directly to a backside of the sample-and-hold display. Thereby the total thickness of the arrangement of display and backlight source can be reduced. In addition, this allows associating emissive areas clearly to a respective aperture hole and delimiting the emissive areas to a size which corresponds basically to the size of the aperture holes. Depending on the glass thickness or scattering properties of the substrates, the emissive areas could also be smaller than the size of the aperture holes.

In an alternative exemplary embodiment of the invention, however, the electroluminescent backlight source is not applied directly to the sample-and-hold display. Instead, at least one optical element is arranged to focus light that is produced by the electroluminescent backlight source to a selected area of the sample-and-hold display. The at least one optical element can be for example a plurality of microlenses or an array of diffractive optical elements. The at least one optical element can be used for example to focus the light provided by a respective emissive area of the backlight source to a respective aperture hole of the sample-and-hold display.

In a further exemplary embodiment of the invention, the backlight control component is moreover configured to receive a partial mode backlight command. Upon receipt of a partial mode backlight command, the backlight control component may then activate only selected portions of the electroluminescent backlight source. This allows highlighting certain items in the display, and other visual effects.

In a further exemplary embodiment of the invention, the backlight control component is moreover enabled to activate different portions of the backlight source with a different intensity. This allows taking care of the problem of existing backlights that an unnecessary lighting of pixels with low gray level values results in a low optical efficiency. An increased content-dependent efficacy may be achieved by reducing the luminance of activated emissive areas for which the corresponding sample-and-hold display pixels are addressed with low gray levels. The front-of-screen luminance is preserved by increasing the gray levels correspondingly for such pixels. The luminance of the backlight source can be set separately for each portion of the electro-luminescent backlight. This will also increase the contrast of the resulting image, because the amount of light leaking out via dark pixels of the sample-and-hold display is reduced.

The sample-and-hold display could be an LCD, but equally any other display having a sample-and-hold characteristic and requiring a backlight.

The employed electroluminescent backlight source can be any electroluminescent light source that can be activated in different portions. Examples are a passive-matrix organic light-emitting diode backlight source (OLED) or a passive-matrix inorganic electroluminescent backlight source.

The backlight source reduces the frame duty from about 1/1 to 1/N, where N is the number of portions of the backlight source. In the case of a passive-matrix OLED backlight source, for example, the data may be written to column buffers and latched simultaneously for one whole row via a row driver. By latching the column buffers sequentially, however, it is possible to decrease the duty even further, thus mimicking a scanning electron beam in a CRT. The amount of sequential latching may depend on how high the peak luminance of the OLED device is and how high the desired average luminance is. Even with a line-wise latching, it is much improved over previous segmented scanning OLEB backlight sources, which are divided typically into less than ten segments. Another improvement is the indicated patterning of emitting areas.

The invention can be employed in particular, though not exclusively, for a small mobile device, for instance a cellular terminal or a mobile TV receiver. It can equally be employed for larger and/or stationary devices, though, like a stationary TV set.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an electronic device according to a first embodiment of the invention;

FIG. 2 is a schematic diagram illustrating the alignment of emissive areas of a backlight source with display pixels in the device of FIG. 1;

FIG. 3 is a schematic diagram illustrating a first option of arranging the display and layers of the backlight source for implementing the alignment of FIG. 2;

FIG. 4 is a schematic diagram illustrating a second option of arranging the display and layers of the backlight source for implementing the alignment of FIG. 2;

FIG. 5 is a flow chart illustrating an operation in the device of FIG. 1;

FIG. 6 is a schematic block diagram of an electronic device according to a second embodiment of the invention;

FIG. 7 is a schematic diagram illustrating the alignment of an emissive area of a backlight source with a display pixel in the device of FIG. 6 using an optical element; and

FIG. 8 is a flow chart illustrating an operation in the device of FIG. 6.

### DETAILED DESCRIPTION OF THE INVENTION

FIG. 1 is a schematic block diagram of an exemplary electronic device, which uses a small, efficient display with reduced motion blur in accordance with an embodiment of the invention.

The exemplary electronic device is a mobile terminal 10, like a mobile phone.

The mobile terminal 10 includes an LCD 11 and a passive-matrix OLED backlight source 12.

The mobile terminal 10 further includes a chip or chipset 14, for instance an integrated circuit (IC).

The chipset 14 comprises an LCD controller circuit 16, which is connected to the LCD 11, and an OLED controller circuit 17, which is connected to the passive-matrix OLED backlight source 12. The LCD controller circuit 16 and the OLED controller circuit 17 are linked to each other. The chip 14 comprises in addition a clock component 18, which is linked to the LCD controller circuit 16 and to the OLED controller circuit 17.

The LCD 11, the passive-matrix OLED backlight source 12 and the chipset 14 may belong to a distinct display module 19. Such a display module 19 would be an exemplary embodiment of the apparatus according to the invention.

It is to be understood that the mobile terminal 10 comprises various other components, including for example a processor, a transceiver and a keypad, which are not shown in FIG. 1.

The LCD 11 can be structured in a conventional manner. The front of the LCD 11 may be covered by a black grid, providing transmissive aperture holes that are arranged in columns and rows. To each transmissive aperture hole, a respective sub-pixel of the LCD 11 is associated, each pixel being composed of three sub-pixels for the color components Red, Green and Blue. In the case of multiprimary colors, the number of sub-pixels could be larger than three.

The passive-matrix OLED backlight source 12 is applied directly to the back of the LCD 11. It is structured such that most of its area does not produce any light. Only very small emissive areas that are placed beneath the transmissive aperture holes of the LCD can be lit. Further, the passive-matrix OLED backlight source 12 is divided into a small number of segments, for example 6 segments. All emissive areas in one segment are controlled in common.

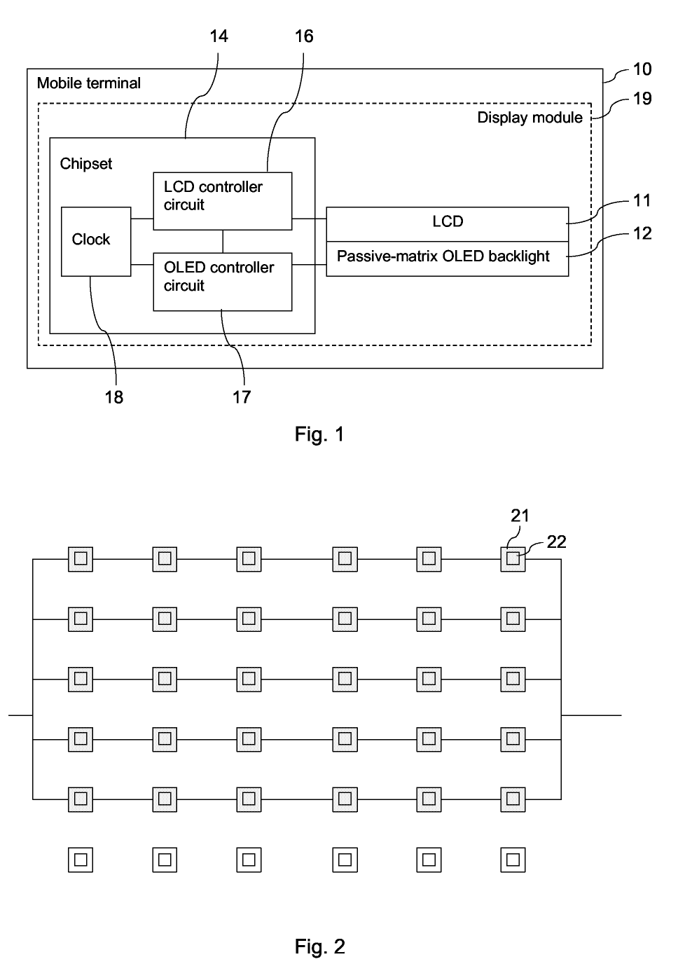

This is illustrated in FIG. 2.

FIG. 2 is a schematic diagram, in which a number of small squares represent some transmissive aperture holes 21 of the LCD 11. In addition, slightly larger squares represent the emissive areas 22 of the OLED backlight source 12. Thirty of the emissive areas 22 of the OLED backlight source 12 are interconnected to illustrate that they belong to one segment that is controlled in common.

The emissive areas of the OLED backlight source 12 could also be smaller than the transmissive aperture holes of the LCD 11, depending on the glass thickness or scattering properties of employed substrates.

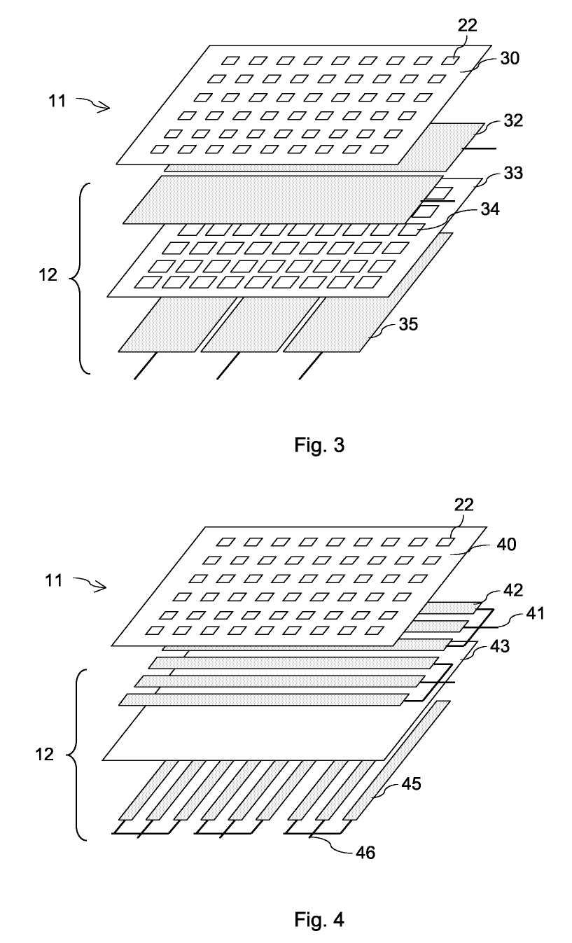

The pattern of the emissive areas 22 of the OLED backlight source 12 can be achieved in various ways. Two options are illustrated schematically in FIGS. 3 and 4.

FIG. 3 presents the LCD 11 as a first layer 30 with small aperture holes 22 arranged in columns and rows.

The passive-matrix OLED backlight source 12 is represented by three further layers.

Two transparent anodes 32 form the second layer. Each of the anodes 32 covers half of the rows of the aperture holes 22 of the LCD 11.

The third layer comprises the layered organic material of the OLED backlight source 12. The third layer is not made up completely of the organic material, though. Rather, the organic material is provided only in small areas 34 arranged in columns and rows, which are encompassed by neutral material 33. Each area 34 is arranged exactly below one of the transmissive aperture holes 22 of the LCD 11. The size of the areas 34 corresponds approximately to the size of the transmissive aperture holes 22. In the present example, the areas 34 are slightly larger than the transmissive aperture holes 22.

Three cathodes 35 form the fourth layer. They are arranged perpendicular to the anodes 32, and each of the cathodes 35 covers one third of the columns of the aperture holes 22 of the LCD 11.

In this embodiment, the emissive areas 21 of the OLED backlight source 12 are defined by the pattern of the organic material itself. The structure of anodes 32 and cathodes 35 defines the segmentation of the OLED backlight source 12. When a voltage is applied between one of the anodes 32 and one of the cathodes 35, all areas 34 lying in the intersection area of the anode 32 and the cathode 35 are lit.

FIG. 4 presents again the LCD 11 as a first layer 40 with small aperture holes 22 arranged in columns and rows.

Moreover, the passive-matrix OLED backlight source 12 is represented again by three further layers.

A plurality of transparent anodes 42 form the second layer. The anodes 42 are arranged in rows. Each anode 42 covers one row of aperture holes 22, without exceeding the height of an aperture hole 22 significantly. The lower half of the anodes 42 and the upper half of the anodes 42, respectively, are connected to a common terminal 41.

The third layer 43 comprises the layered organic material of the OLED backlight source 12. The third layer is structured differently than in the option of FIG. 3, though. More specifically, it is made up completely of the organic material. That is, any area of the second layer 43 could be lit by applying a voltage to the area.

A plurality of cathodes 45 forms the fourth layer. The cathodes 45 are arranged in columns. They are arranged perpendicular to the anodes 42. Each cathode 45 covers one column of aperture holes 22, without exceeding the width of an aperture hole 22 significantly. The cathodes 45 are grouped into left hand cathodes, middle cathodes and right hand cathodes. The cathodes 45 of each group are connected to a common terminal 46.

In this embodiment, the emissive areas 21 of the OLED backlight source 12 are defined by the intersections of the anodes 42 and cathodes 45. The grouping of the anodes 42 and cathodes 45 defines the segmentation of the OLED backlight source 12. When a voltage is applied between one group of anodes 42 and one group of cathodes 45, the areas of the third layer 43 lying in the intersection areas of all anodes 42 of the selected group and all cathodes 45 of the selected group are lit.

It is to be understood that the desired pattern could be obtained in various other ways as well. For example, both options could be combined for instance such that the organic material is provided in rows, while the anodes 32 of FIG. 3 and the cathodes 45 of FIG. 4 are used, etc. Further, the segmentation could be varied in many ways. Each segment of the OLED backlight source 12 could cover for example the entire width of the OLED backlight source 12. This could be achieved in the embodiment of FIG. 4, for instance, by connecting all cathodes 45 to a single terminal and by connecting fewer anodes 42 to a respective single terminal.

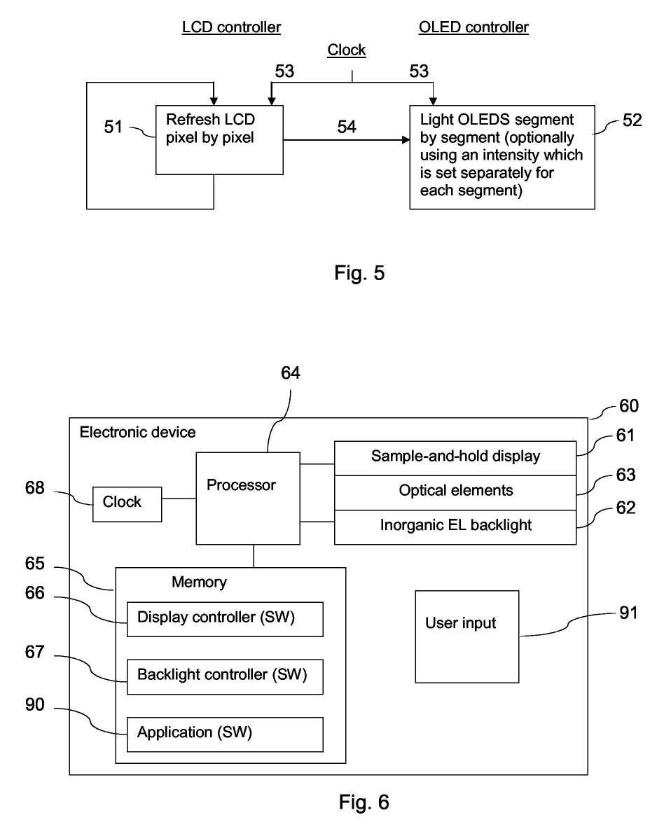

The flow chart of FIG. 5 illustrates the operation in the mobile terminal 10 of FIG. 1.

The LCD controller circuit 16 refreshes the LCD 11 in a conventional sample-and-hold manner. That is, the LCD controller circuit 16 updates the presented image row by row with a predetermined refresh rate. In an LCD controlling each sub-pixel by means of a thin-film transistor (TFT), the pixel data is usually latched to this end to digital-to-analog converters (DAC) of source drivers and then clocked to the pixels by a gate driver pulse. Each pixel maintains its updated state during a hold time. As described above in the background section, the hold time lasts at the most until the state has changed again in the next refresh cycle, that is, after one frame period.

It might be noted that the time at which the state of a pixel changes may be later than the time at which a corresponding refresh signal is provided to the LCD 11. The end of the hold time is determined by either the next refresh signal or the switching time of the molecules. If the display components, including the molecules, respond fast, then the end of the hold time is determined by the next refresh signal. If one or more of the display components, usually the switching time of the molecules, respond very slowly, then the end of the hold time is determined by the slowest component. This means that in some cases, the hold time can be longer than the time of one cycle.

The LCD controller circuit 16 may obtain information from other components of the mobile terminal 10 not shown in FIG. 1, which defines for each refresh cycle the image that is currently to be presented by the LCD 11. (step 51)

In parallel, the OLED controller circuit 17 causes the passive-matrix OLED backlight source 12 to provide a pulsed backlight by subsequently activating one segment after the next of the passive-matrix OLED backlight source 12 (step 52). A segment is activated by applying a voltage between the anodes and cathodes that are associated to a respective segment. As a result, all emissive areas 21 in this segment are lit. The OLED controller circuit 17 activates all segments at least once during each refresh cycle of the LCD controller circuit 16. For slow LCDs, the OLED refresh rate could be larger, in order to eliminate flicker. Further, the OLED controller circuit 17 synchronizes its operation with the operation of the LCD controller circuit 16. That is, a new cycle of the segment activation of the OLED backlight source 12 is started exactly at the same time as a new refresh cycle that is applied to the LCD 11. A phase difference between the OLED and LCD could be introduced, though, in order to let the LCD saturate at the final transmission level before the corresponding OLED segment is switched on.

The same operating speed of LCD controller circuit 16 and OLED controller circuit 17 can be ensured for example by providing both with the same clock signal 53 of clock 18. Further, the LCD controller circuit 16 could trigger each new cycle in the OLED controller circuit 17 by a corresponding control signal 54.

In case the passive-matrix OLED backlight source 12 is divided into six segments, for example, each sub-pixel of the LCD 11 is thus illuminated only ⅙ of the time during which it holds a particular value, that is, from one refresh cycle to the next. This ensures that the amount of motion blur is reduced. Since the OLED backlight source 12 is lit only in the emissive areas 21 under the transmissive aperture holes 22 of the LCD 11, moreover only a small amount of light is wasted and the total luminous efficacy is increased substantially compared to a general backlighting. The segmenting, finally, ensures that the processing load required for the backlight pulsing is limited. It is to be understood that the number of segments and their shapes can be selected arbitrarily.

It has further to be noted that different segments could be activated with different intensities in step 52. That is, the emissive areas 21 in some segments could be caused to emit more light than the emissive areas 21 in some other segments. The LCD controller circuit 16 could inform the OLED controller circuit 17 for instance about the gray levels of the image pixels in each image frame. The OLED controller circuit 17 could then use a lower intensity for those segments, which comprise emissive areas 21 that are associated to aperture holes 22 of image pixels having a lower gray level, and a higher intensity for those segments, which comprise emissive areas 21 that are associated to aperture holes 22 of image pixels having a higher gray level.

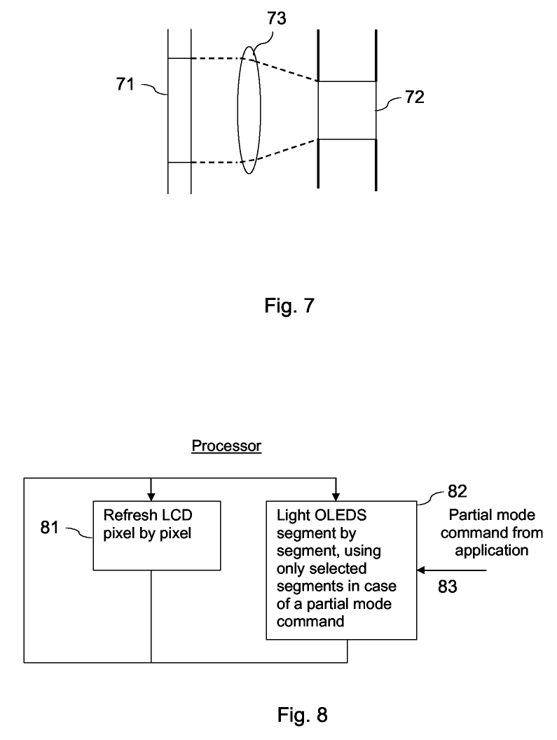

A few variation of the described embodiments will now be presented with reference to FIGS. 6 and 7.

FIG. 6 is a schematic block diagram of another exemplary electronic device, which uses a small, efficient display with reduced blur in accordance with an embodiment of the invention.

The electronic device 60 includes a sample-and-hold display 61 and a backlight source 62. The electronic device 60 could be another device than a mobile terminal, for example a camera or a TV set. The display 61 could be another type of display than an LCD, as long as it has a sample-and-hold characteristic and requires a backlight. The backlight source 62 could be another backlight than a passive-matrix OLED backlight source, for example a passive-matrix inorganic electroluminescent (EL) backlight source.

The sample-and-hold display 61 and the backlight source 62 may be separated by optical elements 63. The optical elements 63 could be microlenses or other diffractive optical elements, like an arrangement of mirrors.

The electronic device 60 further includes a processor 64, which is linked to the display 61 and to the backlight source 62. The processor 64 is adapted to execute various implemented computer program codes. The implemented computer program codes include a display controller code 66 and a backlight controller code 67. The implemented computer program codes may further include an application code 90 for a particular application, which requires a certain presentation on the display 61. The computer program codes may be stored in a memory 65, from which they are retrieved by the processor 64 for execution.

The electronic device 60 further comprises a clock 68, which is linked to the processor 64.

The electronic device 60 comprises in addition various other components, a user input 91 being presented by way of example.

The display 61 comprises a plurality of sub-pixels that are arranged in columns and rows and that require a backlight.

The backlight source 62 is structured such that most of its area is not producing any light. Only very small emissive areas that are placed beneath pixels of the display can be lit. Further, the backlight source 62 is divided into segments. All emissive areas in one segment are controlled in common.

The small emissive areas of the backlight source 62 are still slightly larger than the sub-pixel areas of the display 61. The optical elements are 63 are used to further increase the efficacy of the backlight by focusing the light emitted by one of the emissive areas exactly to the area of one of the sub-pixel areas.

This is schematically illustrated in FIG. 7.

FIG. 7 presents an emissive area 71 of the backlight source 62 and the area of a sub-pixel 72 of the display 61 in a side view. In between both areas 71, 72, an optical element is arranged, by way of example a lens 73. The light that is emitted by the emissive area 71 is focused by the lens 73 exactly to the area of the sub-pixel 72. As a result, a waste of energy due to unused backlight is avoided completely.

It has to be noted that a focusing of light could also be employed when the emissive areas of the backlight source 62 are equal to or smaller than the sub-pixel areas of the display 61. Since the emitted light is not collimated and scattering occurs in the display substrate, the area of the illumination in the plane of the display aperture could be larger than the aperture, even in case of a smaller emissive area. This could be countered by further reducing the original area of incidence of the emitted light on the display.

The display 61 and the backlight source 62 can be controlled in a similar manner as described with reference to FIG. 5 and as illustrated in the flow chart of FIG. 8.

When executed by the processor 64, the display controller code 66 updates the display 61 with a predetermined refresh rate based on received information (step 81). Moreover, the backlight controller code 67 executed by the processor 64 activates the segments of the backlight source 62 in sequence with the same rate and synchronized with the updating by the display controller code 66 to provide a pulsed backlight (step 82).

The executed application code 90 could provide information for the update of the display 61 to the executed display controller code 66, depending on a currently required presentation. In addition, the executed application code 90 could provide information on special requirements to the executed backlight controller code 67. For example, the executed application code 90 could require a partial mode backlight, in which certain items in the display 61 are highlighted, and provide a corresponding partial backlight command to the executed backlight controller code 67 (step 83). In this case, the executed backlight controller code 67 might activate for example only selected ones of the segments during a respective cycle (step 82). Other illumination effects could be supported as well by an application code 90 and the backlight controller code 67. Further, special illumination effects do not rely on a command from an application. They it could also be determined automatically, for example by analyzing the gray levels of the image pixels as indicated above with reference to FIG. 5.

The functions illustrated by the chipset 14 and the processor 64, respectively, can be viewed as means for updating a sample-and-hold display with a predetermined refresh rate and as means for activating segments of an electroluminescent backlight source sequentially to provide a backlight for the sample-and-hold display. Furthermore, these means-plus-function clauses are intended to cover the structures described herein as performing the recited function and not only structural equivalents, but also equivalent structures.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An apparatus comprising:
a sample-and-hold display with a plurality of transmissive aperture holes;
an electroluminescent backlight source with a plurality of delimited emissive areas, wherein a dedicated delimited emissive area is associated to each aperture hole of said sample-and-hold display;
a display controller configured to update said sample-and-hold display with a predetermined refresh rate; and
a backlight controller configured to activate different portions of said electroluminescent backlight source sequentially, each portion comprising a plurality of said emissive areas, configured to receive a partial mode backlight command, and configured to activate only selected portions of said electroluminescent backlight source sequentially upon receipt of a partial mode backlight command.

2. The apparatus according to claim 1, wherein said emissive areas are arranged in lines and columns, and wherein said portions are selected such that at least two portions are required for comprising all emissive areas of a respective entire line of emissive areas.

3. The apparatus according to claim 1, wherein said backlight controller is configured to activate different portions of said electroluminescent backlight source sequentially with a repetition rate, which is equal to or a multiple of said refresh rate used by said display controller.

4. The apparatus according to claim 1, wherein said backlight controller is configured to synchronize said sequential activation of different portions of said electroluminescent backlight source with an update applied by said display controller to said sample-and-hold display.

5. The apparatus according to claim 1, wherein each transmissive aperture hole is associated to a sub-pixel of said sample-and-hold display.

6. The apparatus according to claim 1, wherein said electroluminescent backlight source is directly applied to a backside of said sample-and-hold display.

7. The apparatus according to one of claim 1, further comprising at least one optical element arranged to focus light produced by said electroluminescent backlight source to a selected area of said sample-and-hold display.

8. (canceled)

9. The apparatus according to claim 1, wherein said backlight controller is further configured to adjust an intensity of emissions by emissive areas in a respective portion of said backlight source.

10. The apparatus according to claim 1, wherein said sample-and-hold display is a liquid crystal display.

11. The apparatus according to claim 1, wherein said electroluminescent backlight source is one of a passive-matrix organic light-emitting diode backlight source and a passive-matrix inorganic electroluminescent backlight source.

12. The apparatus according to claim 1, wherein said apparatus is a display module.

13. An electronic device comprising
a sample-and-hold display comprising a plurality of transmissive aperture holes;
an electroluminescent backlight source comprising a plurality of delimited emissive areas, wherein a dedicated delimited emissive area is associated to each transmissive aperture hole of said sample-and-hold display;
a display controller configured to update said sample-and-hold display with a predetermined refresh rate;
a backlight controller configured to activate different portions of said electroluminescent backlight source sequentially, each portion comprising a plurality of said emissive areas, configured to receive a partial mode backlight command, and configured to activate only selected portions of said electroluminescent backlight source sequentially upon receipt of a partial mode backlight command; and
a user input component.

14. The electronic device according to claim 13, further comprising at least one optical element arranged to focus light produced by said electroluminescent backlight source to a selected area of said sample-and-hold display.

15. (canceled)

16. The electronic device according to claim 13, wherein said backlight controller is further configured to adjust an intensity of emissions by emissive areas in a respective portion of said backlight source.

17. The electronic device according to claim 13, wherein said electronic device is a mobile terminal.

18. A method comprising:
updating a sample-and-hold display comprising a plurality of transmissive aperture holes with a predetermined refresh rate; and
sequentially activating different portions of an electroluminescent backlight source comprising a plurality of delimited emissive areas, wherein a dedicated delimited emissive area is associated to each transmissive aperture hole of said sample-and-hold display, and wherein different portions of said electroluminescent backlight source are activated such that each portion comprises a plurality of said emissive areas of said electroluminescent backlight source;
wherein said activating of different portions comprises activating only selected portions of said electroluminescent backlight source sequentially, in case a partial mode backlight command is received.

19. (canceled)

20. (canceled)

21. (canceled)

22. (canceled)

23. (canceled)

24. A computer readable medium in which a computer program code is stored, said computer program code realizing the following when executed by a processor:
updating a sample-and-hold display comprising a plurality of transmissive aperture holes with a predetermined refresh rate; and
sequentially activating different portions of an electroluminescent backlight source comprising a plurality of delimited emissive areas, wherein a dedicated delimited emissive area is associated to each transmissive aperture hole of said sample-and-hold display, and wherein different portions of said electroluminescent backlight source are activated such that each portion comprises a plurality of said emissive areas of said electroluminescent backlight source;
wherein said activating of different portions comprises activating only selected portions of said electroluminescent backlight source sequentially, in case a partial mode backlight command is received.

25. The computer program product according to claim 24, wherein said activating of different portions comprises activating said different portions of said electroluminescent backlight source sequentially with a repetition rate, which is equal to or a multiple of said refresh rate used in said updating of said sample-and-hold display.

26. The computer program product according to claim 24, wherein said activating of different portions comprises synchronizing said sequential activation of different portions of said electroluminescent backlight source with said updating of said sample-and-hold display.

27. (canceled)

28. (canceled)
